(19) United States
(12) Patent Application Publication
(10) Pub. No.: US 2015/0106147 A1
(43) Pub. Date: Apr. 16, 2015

(54) SYSTEM AND METHOD FOR ELECTRONICALLY SENDING A CALENDAR INVITE

(71) Applicant: SYNTEL, INC., TROY, MI (US)

(72) Inventors: DHEERAJ ANIL PATANKAR, PUNE (IN); MORESHWAR MARNE, PUNE (IN)

(73) Assignee: SYNTEL, INC., TROY, MI (US)

(21) Appl. No.: 14/052,241

(22) Filed: Oct. 11, 2013

(51) Int. Cl. G06Q 10/10

(52) U.S. Cl. CPC G06Q 10/1095
USPC 705/7.19

(57) ABSTRACT

A system, method, and computer program product for generating an electronic calendar invitation for an event is disclosed. The system includes memory for storing instructions and data associated with a calendar invite tool. A processor is configured to execute the stored instructions. The instructions may cause the processor to perform the steps including: allowing a user to create an electronic message associated with an event reservation application of a first platform, wherein the electronic message includes electronic address information associated with one or more invitees; based on the electronic address information, generating the electronic calendar invitation of a second platform different from the first platform; and sending the electronic calendar invitation to the one or more invitees in accordance with the electronic address information.

### TECHNICAL FIELD

This disclosure relates generally to computerized systems, and, in particular, this disclosure relates to a computerized system that is programmed to electronically send calendar invites.

### BACKGROUND

Among other things, advances in information technology and the Internet have resulted in an increased presence of Internet-based reservation programs, such as Expedia™, Travelocity™, OpenTable™, and the like. Internet-based reservation programs allow consumers to reserve flights, conference rooms, hospital rooms, hotel rooms, etc. Oftentimes, these reservations are made in conjunction with a particular event or meeting requiring the attendance of many individuals. Prospective event attendees may be notified of the event by electronic mail linked to an electronic calendar application. Microsoft Outlook™, for example, offered by the Microsoft Corporation of Redmond, Wash., provides a user with a way to invite one or more potential participants to join a meeting or attend an event via a meeting request email sent to their email address.

Creating and sending electronic calendar invitations can sometimes be tedious. For example, invitees may use different email applications running on platforms not having electronic calendar functionality. In some cases, email applications do not allow a time slot to be reserved on a personal electronic calendar through a received email, as well as other calendar functionality offered an electronic calendar application of Microsoft Outlook™. Also, it may be advantageous if a user on a reservation website could employ the use of an electronic calendar application within the reservation website (even though potentially running on a different platform than Microsoft™) instead of having to open a separate email application that is potentially incapable of sending an electronic calendar invite to prospective attendees.

Therefore, there is a need for a tool that can be configured to run on any application (e.g., reservation website) or platform, and capable of generating and sending calendar invitations (e.g., Outlook™ invitations) to prospective attendees.

### SUMMARY

According to one aspect, the disclosure provides a computerized system for generating an electronic calendar invitation for an event. The system includes memory for storing instructions and data associated with a calendar invite tool. A processor is configured to execute the stored instructions. The instructions may cause the processor to perform the steps including: allowing a user to create an electronic message associated with an event reservation application of a first platform, wherein the electronic message includes electronic address information associated with one or more invitees; based on the electronic address information, generating the electronic calendar invitation of a second platform different from the first platform; and sending the electronic calendar invitation to the one or more invitees in accordance with the electronic address information. The instructions may also cause the processor to perform the additional step of automatically populating a body of the electronic calendar invitation with reservation information of the event reservation application.

According to another aspect, the disclosure provides a computerized system for receiving an electronic calendar invitation for an event. The system includes memory for storing instructions and data associated with a calendar invite tool. A processor is configured to execute the stored instructions. The instructions may cause the processor to perform the steps including: receiving, at an electronic mail system on a first platform, an electronic calendar invitation generated from an online reservation application of a second platform; and allowing the recipient to save the electronic calendar invitation to an electronic calendar associated with the recipient in response to the recipient accepting the electronic calendar application.

Additional features and advantages of the will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a diagrammatical view of an example computing device that may be included in the system and that may be programmed to carry out various methods taught herein according to one embodiment of the disclosure;

FIG. 2 is a flow diagram of an example system according to one embodiment of the disclosure;

FIG. 3 is an example screenshot of a calendar invite tool of the system for generating a calendar invite according to one embodiment of the disclosure;

FIG. 4 is an example screenshot of a calendar invite tool of the system for generating a calendar invite according to one embodiment of the disclosure; and

FIG. 5 is an example screenshot of a calendar invite tool of the system for receiving a calendar invite generated by the calendar invite tool according to one embodiment of the disclosure.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

Embodiments of the disclosure are directed to a computerized system programmed with a calendar invite tool configured to generate and send calendar invitations to an individual or group, irregardless of the type of application for which the tool is developed. In other words, the calendar invitation tool is application agnostic. As used herein, the calendar invitations may take the form of Microsoft Outlook™ calendar invitations as offered by Microsoft Corporation of Redmond, Wash. As such, the tool may be capable of generating an Outlook calendar invite, although the tool may be developed for an application not having Microsoft Outlook™ functionality.

In certain embodiments, the calendar invite tool is developed for any application that is developed on the .NET™ platform, as offered by the Microsoft Corporation of Redmond, Wash. Using the .NET™ platform, the tool could take advantage of a base class library and a common language runtime environment. The base class library may provide user interface, data access database connectivity, cryptography, web application development, numeric algorithms, and network communications. The common language environment includes a language-neutral platform for application development and execution, including functions for exception handling, garbage collection, security, and interoperability.

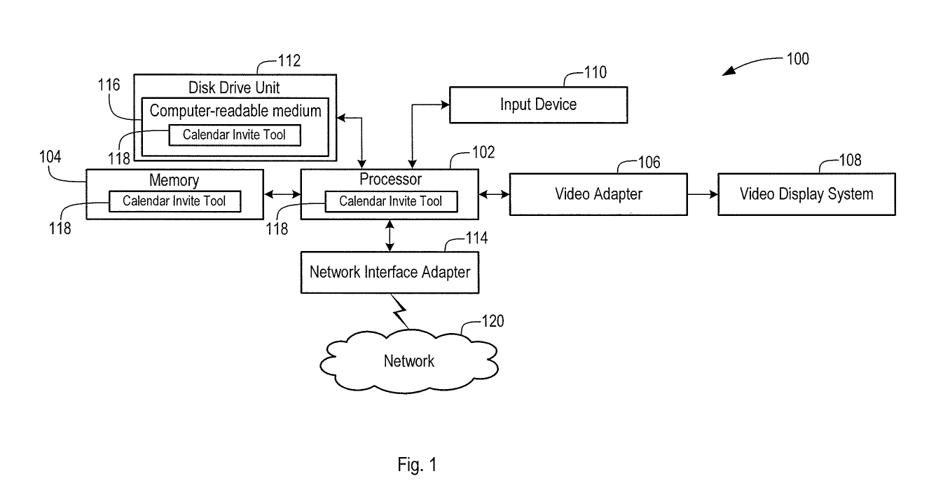

FIG. 1 illustrates a diagrammatic representation of a machine 100, in the example form of a computer system, that may be programmed with a set of instructions to perform any one or more of the methods discussed herein. The machine may be a personal computer, a notebook computer, a server, a tablet computer, a personal digital assistant (“PDA”), a cellular telephone, or any machine capable of executing a set of instructions (sequential or otherwise) that specify actions to be taken by that machine.

The machine 100 may operate as a standalone device or may be connected (e.g., networked) to other machines. In embodiments where the machine is a standalone device, the set of instructions could be a computer program stored locally on the device that, when executed, causes the device to perform one or more of the methods discussed herein. Consider an example in which the machine 100 is a tablet device, such as an iPad™ or Android™ device; the computer program could be an “app” installed on the tablet device. In embodiments where the computer program is locally stored, data may be retrieved from local storage or from a remote location via a network. In a networked deployment, the machine 100 may operate in the capacity of a server or a client machine in server-client network environment, or as a peer machine in a peer-to-peer (or distributed) network environment. Although only a single machine is illustrated in FIG. 1, the term “machine” shall also be taken to include any collection of machines that individually or jointly execute a set (or multiple sets) of instructions to perform any one or more of the methods discussed herein.

The example machine 100 illustrated in FIG. 1 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the machine 100 will not always include all of these peripheral devices.

The disk drive unit 112 includes a computer-readable medium 116 on which is stored one or more sets of computer instructions and data structures embodying or utilized by a site viewer tool 118 described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the site viewer tool 118 may be transmitted or received over a network 120 via the network interface device 114 utilizing any one of a number of transfer protocols including but not limited to the hypertext transfer protocol (“HTTP”) and file transfer protocol (“FTP”).

The network 120 may be any type of communication scheme including but not limited to fiber optic, cellular, wired, and/or wireless communication capability in any of a plurality of protocols, such as TCP/IP, Ethernet, WAP, IEEE 802.11, or any other protocol.

While the computer-readable medium 116 shown in the example embodiment of FIG. 1 is a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. These instructions may also include, for example, classes, such as the following:

Class Name: OutLookInviteUtility
Namespace: AutoEmailCalendarInvite.OutLookInviteUtility
Class Name: OutLookInviteUtility

Description:
Provides properties and method to generate outlook appointment invite and send the same to desired participants.

Properties:
public string AttendeesList: List of Attendees
public string FromEmailId: Meeting request generator ID
public string Subject: Subject of the Request
public string SMTPHostName: SMTP server name

Functionality:
Member: User or group for role assignment
RoleDefinitionBindings: Collection of role definition bindings for role assignment

Methods:
Public void SendMail: Generates calendar invite file and sends the same.

The term “computer-readable medium” shall accordingly be taken to include, but not be limited to, solid-state memories, optical media, flash memory, and magnetic media.

For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

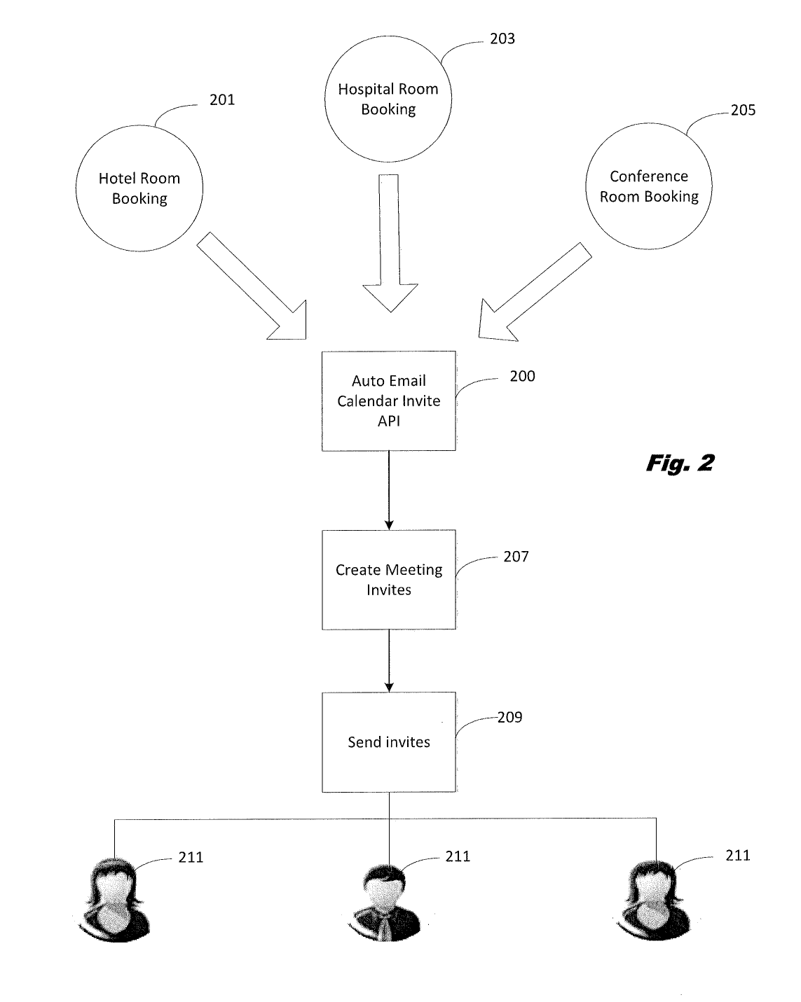

In light of the foregoing, and as illustrated in FIG. 2, embodiments of the disclosure employ an invite calendar tool 200 which may be developed on numerous types of applications, such as a travel reservation website 201(e.g., for booking a hotel room or flight), conference room reservation application 203, and a hospital room reservation application 205. In conjunction with any one or more of the above applications 201, 203, and 205, the tool may programmatically allow a user to conveniently transfer booking (i.e., reservation) information into an email for generation as an electronic calendar invitation 207(e.g., an Outlook™ invitation). Alternatively, the tool may automatically populate the calendar invitation with portions of the reservation information already input to any of the reservation applications. At 209, the tool may then electronically send the generated calendar invitation to the desired recipients 211.

As used herein, the term “event” and “meeting” are used interchangeably, and may be defined as a gathering of people in a particular place at a particular time for a particular purpose. Examples of events include, but are not limited to, conferences, conventions, tradeshows, training sessions, users groups, retreats, etc. An event can also be a virtual or hybrid (physical/virtual) event where the meeting takes place online accessible to attendees on the web or via mobile applications.

In order to generate an event or meeting request, the user typically interacts with the scheduling application through a user interface. The user interface provides the user with a plurality of selectable options to parameterize the meeting request. For example, the user interface typically allows the user to pick a date and time (and often a place) on which the meeting is to be held. The user interface also typically allows the user to select a group of attendees that the user wishes to attend the meeting, to enter some textual description of the meeting.

Based on this information, the tool creates an object which is representative of the meeting and enters it on the user's calendar as an appointment. Such objects are typically defined by a number of properties, some of which are defined by the user input information which the user provides while generating the meeting request.

Because other people are identified as attendees, the appointment entered on the calendar is viewed as a meeting and the calendar tool may call methods exposed by an electronic mail application in accordance with messaging application programming interfaces (“MAPI”), or other APIs which are a set of well documented, published interfaces commercially available from the Microsoft Corporation of Redmond, Wash.

In response, the electronic mail application creates another object (an electronic mail meeting request object) indicative of the meeting request and the electronic mail application (or suitable transport) formats this electronic mail meeting request object into a well defined electronic mail message suitable for transmission. The electronic mail application then interacts with a specified transport and transports the electronic mail meeting request object to a network which routes it to the designated attendees. For example, embodiments of the disclosure may employ the use of a simple mail transfer protocol (“SMTP”) for sending the email messages between servers.

The potential attendees may then respond to the meeting request. The response is then transmitted back to the originator (e.g., the sending computer). The electronic mail application and scheduling application on the originator then typically process the response (or responses) accordingly.

As an example in operation, a meeting organizer may be using an Internet-based travel reservation website, such as Expedia™. After making hotel arrangements for an upcoming meeting, the organizer may wish to notify prospective attendees of hotel specifics (e.g., name and address of hotel, check-in time, etc.), meeting specifics (e.g., exact meeting date, time, location, agenda, etc.), and any other information regarding the meeting. The organizer may conveniently open the tool from the travel reservation website, and either copy and paste any of the above discussed information, or have the tool automatically populate certain email fields based on the hotel arrangements recently made. For example, the tool may automatically take the recently booked hotel information, and enter this information into a body of an email the organizer wishes to send to prospective attendees.

The organizer may then enter email addresses of those individuals or groups he or she wishes to invite. In accordance with the meeting information, and email addresses, the tool generates calendar invitations to the invitees. The invitees may then receive these invitations, and are subsequently able to save the same to his or her respective electronic calendar application (e.g., Microsoft Outlook™)

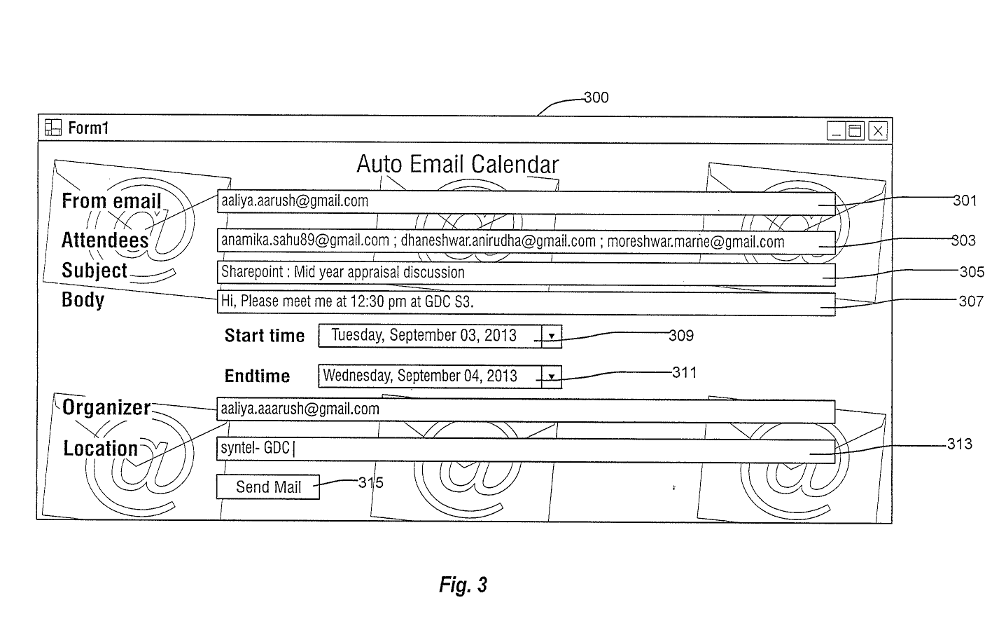

Upon installation of the calendar invite tool, a user (e.g., an organizer) may be presented with a meeting creation window 300, which may be associated or operate in conjunction with a reservation application (e.g., Expedia™). The meeting creation window 300 allows the user to enter information pertaining to an invitation that is to be sent out to a group of people, herein referred to as invitees, about a meeting. As can be seen in FIG. 3, the meeting creation window 300 allows the user (identified by email address in field 301) to enter information about, for example, the prospective attendees electronic addresses in attendee address field 303, the subject 305 of the meeting, a body 307 of the email containing specific details of the meeting when the start time 309 and end time 311 of the meeting, the location 313 of the meeting. It should be noted that these fields are not limiting, and that the user may be allowed to enter other types of information related to the meeting as well.

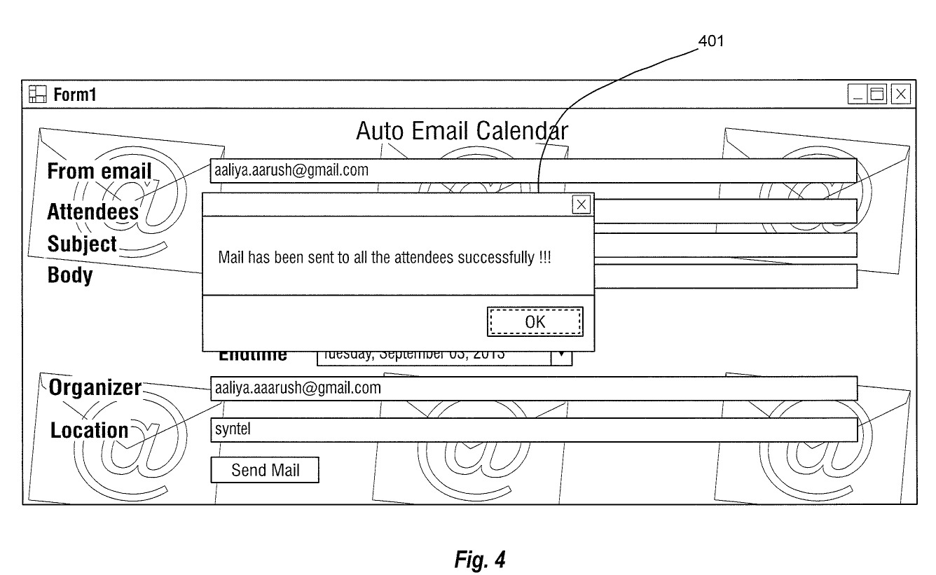

Upon clicking the send button 315 (as shown in FIG. 3), a popup window 401, as shown in the example screenshot in FIG. 4, may appear, which acts as confirmation of successfully delivery of the invitation to the listed attendees.

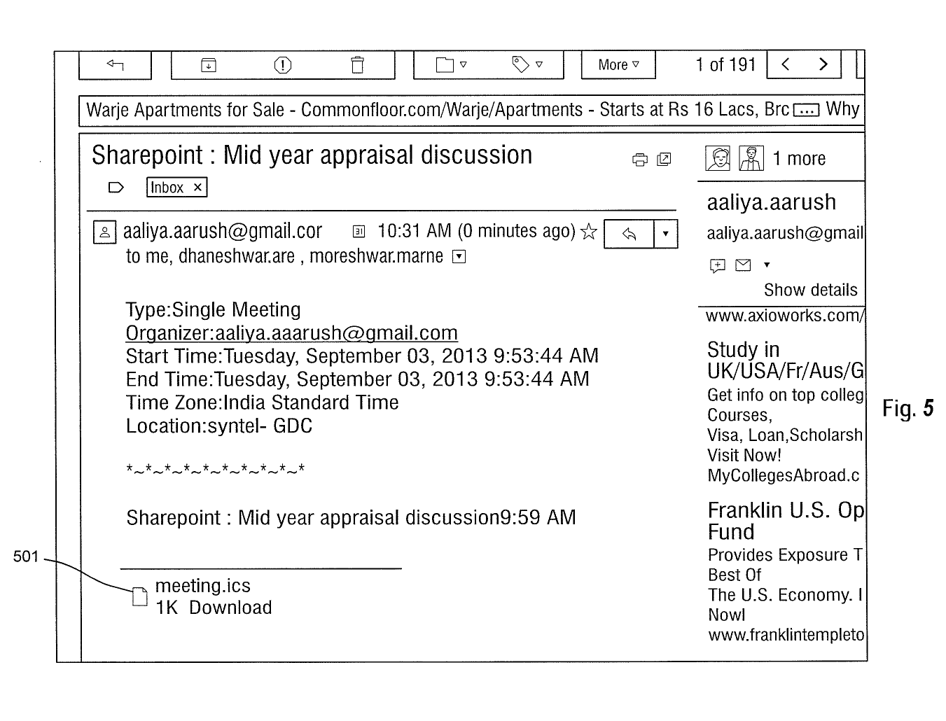

FIG. 5 is an example screenshot of an electronic message received by one of the listed attendees. As shown, this message includes information concerning the scheduled meeting, as well as an attachment 501 that the recipient can download which, in turn, may place the meeting parameters onto the recipient's electronic calendar.

In light of the foregoing, it is contemplated that the tool can be used by any type of .NET applications which could employ, for example, Console™, WinForms™, Windows Presentation Foundation™ (“WPF”) or Web functionality.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed:

1. A computerized system of generating an electronic calendar invitation for an event, the system comprising:
one or more computing devices including:
a memory having program code stored therein;
a processor in communication with the memory configured to carry out instructions in accordance with the stored program code, wherein the program code, when executed by the processor, causes the processor to perform operations comprising:
creating an electronic calendar invitation associated with an event reservation application of a first platform, wherein the electronic calendar invitation includes an electronic address of at least one invitee;
based on the electronic address information, translating the electronic calendar invitation into a format compatible with a second platform different from the first platform; and
sending the translated electronic calendar invitation to the invitee in accordance with the electronic address.

2. The system of claim 1, further comprises automatically populating a body of the electronic calendar invitation with reservation information of the event reservation application.

3. The system of claim 2, wherein the reservation information comprises conference room reservation information.

4. The system of claim 1, wherein, upon acceptance of the electronic calendar invitation by the invitee, the electronic calendar invitation is configured to remind the invitee of the event associated with the electronic calendar invitation.

5. The system of claim 1, wherein the system is application-agnostic.

6. The system of claim 1, wherein the sending comprises using a simple mail transport protocol (“SMTP”).

7. The system of claim 1, wherein, upon receipt of the electronic calendar invitation by the invitee, the electronic calendar invitation is configured to be inserted into one or more electronic calendars associated with the invitee.

8. A computerized system for receiving an electronic calendar invitation for an event, the system comprising:
one or more computing devices including:
a memory having program code stored therein;
a processor in communication with the memory configured to carry out instructions in accordance with the stored program code, wherein the program code, when executed by the processor, causes the processor to perform operations comprising:
receiving, at an electronic mail system on a first platform, an electronic calendar invitation generated from an online reservation application of a second platform; and
allowing the recipient to save the electronic calendar invitation to an electronic calendar associated with the recipient in response to the recipient accepting the electronic calendar application.

9. The system of claim 8, wherein a body of the electronic calendar invitation was automatically populated with the reservation information of the event reservation application.

10. The system of claim 9, wherein the reservation information comprises lodging reservation information.

11. The system of claim 9, wherein the reservation information comprises conference room reservation information.

12. The system of claim 8, wherein the system is application-agnostic.

13. The system of claim 8, wherein the sending comprises using a simple mail transport protocol (“SMTP”).

14. A computerized system for generating an electronic calendar invitation for an event, the system comprising:
one or more computing devices including:
a memory having program code stored therein;
a processor in communication with the memory configured to carry out instructions in accordance with the stored program code, wherein the program code, when executed by the processor, causes the processor to perform operations comprising:
allowing a user to create an electronic message associated with an event reservation application of a first platform, wherein the electronic message includes electronic address information associated with one or more invitees;
based on the electronic address information, generating the electronic calendar invitation of a second platform different from the first platform;
automatically populating a body of the electronic calendar invitation with reservation information of the event reservation application; and
sending the electronic calendar invitation to the one or more invitees in accordance with the electronic address information.

15. The system of claim 14, wherein the reservation information comprises lodging reservation information.

16. The system of claim 14, wherein the reservation information comprises conference room reservation information.

17. The system of claim 14, wherein the system is application-agnostic.

18. The system of claim 14, wherein the sending comprises using a simple mail transport protocol (“SMTP”).

19. The system of claim 14, wherein, upon receipt of the electronic calendar invitation by the one or more invitees, the electronic calendar invitation is configured to be inserted into one or more electronic calendars associated with the one or more invitees.

20. The system of claim 14, wherein, upon acceptance of the electronic calendar invitation by the one or more invitees, the electronic calendar invitation is configured to remind the one or more invitees of the event associated with the electronic calendar invitation.
